(19) United States
(12) Patent Application Publication
(10) Pub. No.: US 2017/0126399 A1
(43) Pub. Date: May 4, 2017

(54) ENCRYPTION APPARATUS, STORAGE SYSTEM, DECRYPTION APPARATUS, ENCRYPTION METHOD, DECRYPTION METHOD, AND COMPUTER READABLE MEDIUM

(71) Applicant: Mitsubishi Electric Corporation, Tokyo (JP)

(72) Inventor: Toru SORIMACHI, Tokyo (JP)

(73) Assignee: MITSUBISHI ELECTRIC CORPORATION, Tokyo (JP)

(21) Appl. No.: 15/301,565

(22) PCT Filed: May 14, 2014
(86) PCT No.: PCT/JP2014/062822

§ 371 Date: Oct. 3, 2016

(51) Int. Cl. H04L 9/06; H04L 9/08

(52) U.S. Cl. CPC H04L 9/0637; H04L 9/0625; H04L 9/0861

(57) ABSTRACT

In an encryption apparatus, a division part determines as a unit of processing, the number of blocks to be encrypted using the same key, and divides plaintext data input from a second input part by the unit of processing. An encryption part generates from a common key input from a first input part, processing keys 1 to N which are different from each other and the number of which is the same as the number N of divisions of the plaintext data at the division part, and generates encrypted data by encrypting for each unit of processing determined by the division part, individual blocks of the plaintext data input from the second input part, by means of a block cipher F using the same generated processing key I.

### TECHNICAL FIELD

The present invention relates to an encryption apparatus, a storage system, a decryption apparatus, an encryption method, a decryption method, an encryption program, and a decryption program. The present invention relates to, for example, a technique for encryption and decryption that enables low latency processing in a common key cryptographic scheme.

### BACKGROUND ART

In recent years, various services utilizing a computer or a communication apparatus have been provided. In these services, in order to realize confidentiality or authentication of communication, a cryptographic technique has been mostly used. A cryptographic scheme is broadly classified into a common key cryptography and a public key cryptography. The common key cryptography uses the same key for encryption and decryption, and the public key cryptography uses two different types of keys that are a secret key and a public key. In the common key cryptography, a method for sharing the key between a sender and a receiver is a problem. However, there is an advantage in the common key cryptography that a processing amount required for encryption and decryption is less compared with the public key cryptography. Therefore, the common key cryptography has been used in many fields and uses.

In order to realize an application that emphasizes a response speed, such as read and write processing of a secure storage device, the need of cryptography that enables low latency processing having real-time property has been grown. A common key cryptographic technique that enables the execution of the low latency processing has been severally proposed until now (e.g., refer to Non-Patent Literature 1).

In Non-Patent Literature 1, as a design example of a common key encryption algorithm that enables the low latency processing, a low latency block encryption algorithm PRINCE which was published in ASIACRYPT 2012 is proposed. In Non-Patent Literature 1, the safety of PRINCE is evaluated compared by means of a block cipher that has been known until now. However, evaluations against differential cryptanalysis and linear cryptanalysis are basically required for the block cipher. In Non-Patent Literature 1, the provable safety of PRINCE against the differential cryptanalysis and the linear cryptanalysis is not indicated.

A technique for protecting a mounting module of the common key encryption algorithm from an external monitoring attack has been severally proposed until now (e.g., refer to Patent Literature 1).

In Patent Literature 1, a technique for providing security against the external monitoring attack is proposed by calculating a plurality of continuous intermediate keys from a secret key to be used for the common key encryption algorithm and deriving a message key from an internal secret state and a message identifier.

### CITATION LIST

### Patent Literature

Patent Literature 1: JP 2013-513312 A

### Non-Patent Literature

Non-Patent Literature 1: J. Borghoff, A. Canteaut, T. Guneysu, E. B. Kavun, M. Knezevic, L. R. Knudsen, G. Leander, V. Nikov, C. Paar, C. Rechberger, P. Rombouts, S. S. Thomsen, T. Yalcin, “PRINCE—A Low-latency Block Cipher for Pervasive Computing Applications”, Advances in Cryptology—ASIACRYPT 2012, Lecture Notes in Computer Science Volume 7658, 2012, pp 208-225

### SUMMARY OF INVENTION

### Technical Problem

The design development of the common key encryption algorithm is generally completed by evaluating the safety of an algorithm in itself against various types of cryptanalyses and determining a specification of the algorithm. In order to utilize the developed algorithm to an actual system, the development of a cipher module considering required conditions such as operation condition and processing performance has been separately carried out. Therefore, when the required conditions of the system that applies the algorithm are severe, the development of the cipher module takes a lot of time and efforts. In some cases, a scheduled encryption algorithm cannot be applied, and thereby another encryption algorithm with lower safety is employed.

In the development of an encryption algorithm, safety and processing performance are in a relationship of trade-off. Conventionally, a scheme for efficiently achieving high safety and low latency processing at the same time has not been proposed. For example, in the above described low latency block encryption algorithm PRINCE employs a scheme for reducing processing latency as much as possible by simplifying internal computation processing by setting a safety margin to be equal to or less than a general block cipher as the required specification of the algorithm.

The present invention aims to, for example, achieve both high safety and low latency processing in a scheme for encryption or decryption.

### Solution to Problem

An encryption apparatus to encrypt plaintext data by means of a block cipher according to one aspect of the present invention includes:

a division part to determine as a unit of processing, a number of blocks to be encrypted using a same key, and divide the plaintext data by the unit of processing; and

an encryption part to generate from a common key, processing keys which are different from each other and a number of which is same as a number of divisions of the plaintext data at the division part, and generate encrypted data by encrypting for each unit of processing determined by the division part, individual blocks of the plaintext data by means of the block cipher using same one of the generated processing keys.

A decryption apparatus to decrypt encrypted data by means of a block cipher according to one aspect of the present invention includes:

a division part to determine as a unit of processing, a number of blocks to be decrypted using a same key, and divide the encrypted data by the unit of processing; and

a decryption part to generate from a common key, processing keys which are different from each other and a number of which is same as a number of divisions of the encrypted data at the division part, and generate plaintext data by decrypting for each unit of processing determined by the division part, individual blocks of the encrypted data by means of the block cipher using same one of the generated processing keys.

### Advantageous Effects of Invention

In the present invention, a predetermined number of blocks is determined as a unit of processing, and for each unit of processing, individual blocks of plaintext data (or encrypted data) are encrypted (or decrypted) by means of a block cipher using the same processing key. Therefore, in accordance with the present invention, it becomes possible to achieve both high safety and low latency processing in a scheme for encryption (or decryption).

### BRIEF DESCRIPTION OF DRAWINGS

FIG. 1 is a block diagram illustrating a configuration of an encryption apparatus according to a first embodiment.

FIG. 2 is a block diagram illustrating a first configuration example of an encryption part of the encryption apparatus according to the first embodiment.

FIG. 3 is a table illustrating data sizes processable by the encryption apparatus according to the first embodiment.

FIG. 4 is a block diagram illustrating a second configuration example of the encryption part of the encryption apparatus according to the first embodiment.

FIG. 5 is a diagram illustrating a configuration example of a block cipher that can be used in the example of FIG. 4.

FIG. 6 is a block diagram illustrating a third configuration example of the encryption part of the encryption apparatus according to the first embodiment.

FIG. 7 is a diagram illustrating a configuration example of the block cipher that can be used in the example of FIG. 6.

FIG. 8 is a block diagram illustrating a configuration of a decryption apparatus according to a second embodiment.

FIG. 9 is a block diagram illustrating a configuration of a storage system according to a third embodiment.

FIG. 10 is a diagram illustrating one example of a hardware configuration of each of the encryption apparatus, the decryption apparatus, and the storage system according to the embodiments of the present invention.

### DESCRIPTION OF EMBODIMENTS

Embodiments of the present invention will be described hereinafter with reference to accompanying drawings.

### First Embodiment

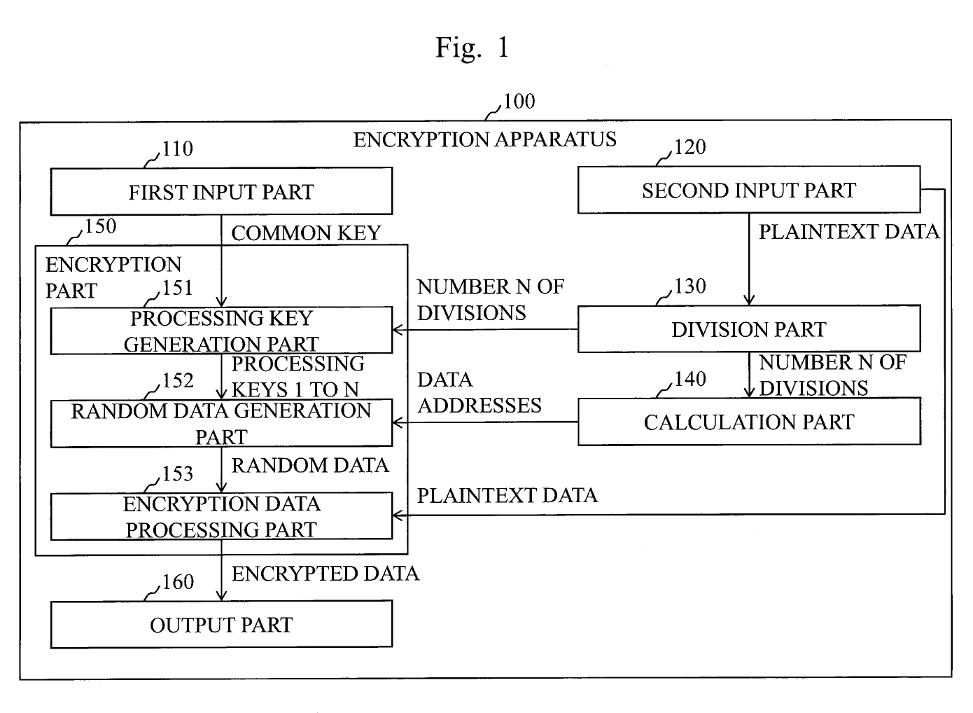

FIG. 1 is a block diagram illustrating a configuration of an encryption apparatus 100 according to the present embodiment.

The encryption apparatus 100 encrypts plaintext data (also referred to as “processing data”) by means of a block cipher F.

Referring to FIG. 1, the encryption apparatus 100 includes a first input part 110, a second input part 120, a division part 130, a calculation part 140, an encryption part 150, and an output part 160.

The first input part 110 has an interface function to receive from the outside a common key (also referred to as a “secret key”) to be used for the block cipher F. The first input part 110 holds the common key received from the outside in a memory. The first input part 110 transmits the common key held in the memory to the encryption part 150.

As just described, the first input part 110 inputs the common key to the encryption part 150.

The second input part 120 has an interface function to receive from the outside the plaintext data to be encrypted by means of the block cipher F. The second input part 120 holds the plaintext data in the memory. The second input part 120 transmits the plaintext data held in the memory to the division part 130 and the encryption part 150.

As just described, the second input part 120 inputs the plaintext data to the division part 130 and the encryption part 150.

The division part 130 identifies a data size (i.e., a unit of processing×a block length) processable with the same key, the data size being derived from a safety evaluation result of an encryption algorithm (i.e., the block cipher F) to be used by the encryption part 150. The division part 130 computes from the identified data size and the size of the plaintext data input from the second input part 120, the number N of divisions of the plaintext data (i.e., the number of groups where the plaintext data is divided into the groups by the unit of processing). Then, the division part 130 notifies the calculation part 140 and the encryption part 150 of the number N of the divisions.

As just described, the division part 130 determines as the unit of processing, the number of blocks to be encrypted using the same key, and divides the plaintext data input from the second input part 120 by the unit of processing. The unit of processing is appropriately determined depending on a configuration (e.g., the S-box size, the number of layers, and the block length) of the block cipher F by the division part 130. Alternatively, the unit of processing is specified in advance depending on the configuration of the block cipher F, and the specified unit of processing is employed by the division part 130. Alternatively, the upper limit of the unit of processing is specified in advance depending on the configuration of the block cipher F and the unit of processing is set equal to or less than the upper limit by the division part 130. As described below, the unit of processing is preferably determined depending on an average differential probability or an average linear probability of the block cipher F. Especially, by determining a reciprocal of the average differential probability or the average linear probability of the block cipher F as the unit of processing, encryption processing can be optimized while securing safety.

The calculation part 140 identifies from the number N of the divisions notified from the division part 130 and address information of the plaintext data input from the second input part 120, data addresses of individual blocks included in each of block groups 1 to N of the divided plaintext data. The calculation part 140 transmits to the encryption part 150, the identified data addresses and information of the block groups to which the blocks corresponding to those respective data addresses belong.

As just described, the calculation part 140 calculates the data addresses of the individual blocks of the plaintext data.

The encryption part 150 includes a processing key generation part 151, a random data generation part 152, and an encryption data processing part 153.

The processing key generation part 151 receives the common key from the first input part 110 and generates processing keys (also referred to as “previously generated keys”) 1 to N the number of which is the same as the number N of the divisions notified from the division part 130. Then, the processing key generation part 151 transmits the processing keys 1 to N to the random data generation part 152.

As just described, the processing key generation part 151 generates from the common key input from the first input part 110, the processing keys 1 to N which are different from each other and the number of which is the same as the number N of the divisions of the plaintext data at the division part 130. For example, the processing key generation part 151 generates the processing keys 1 to N by encrypting pieces of data which are different from each other and the number of which is the same as the number N of the divisions of the plaintext data at the division part 130, by means of the block cipher F using the common key input from the first input part 110.

The random data generation part 152 and the encryption data processing part 153 generate the encrypted data by encrypting for each unit of processing determined by the division part 130, individual blocks of the plaintext data input from the second input part 120, by means of the block cipher F using the same processing key I (I=1, 2, . . . , and N) generated by the processing key generation part 151.

Specifically, the random data generation part 152 firstly receives the processing keys 1 to N from the processing key generation part 151, and the data addresses and the information of the block groups from the calculation part 140. The random data generation part 152 executes with respect to a block group I, the encryption processing where the data addresses are used as input data of the block cipher F and the processing key I is used as key data of the block cipher F. Then, the random data generation part 152 transmits random data being output data of the block cipher F to the encryption data processing part 153.

As just described, the random data generation part 152 encrypts for each unit of processing determined by the division part 130, the data addresses of the individual blocks calculated by the calculation part 140, by means of the block cipher F using the same processing key I generated by the processing key generation part 151.

Next, the encryption data processing part 153 receives the random data from the random data generation part 152 and the plaintext data from the second input part 120, and executes a predetermined computation. The encryption data processing part 153 transmits the encrypted data being the computation result to the output part 160.

As just described, the encryption data processing part 153 generates the encrypted data from the data addresses of the individual blocks encrypted by the random data generation part 152 and the individual blocks of the plaintext data input from the second input part 120. For example, the encryption data processing part 153 calculates an exclusive OR of each of the data addresses of the individual blocks encrypted by the random data generation part 152 and a corresponding one of the individual blocks of the plaintext data input from the second input part 120, and outputs the calculation result as the encrypted data.

The output part 160 receives the encrypted data from the encryption data processing part 153. The output part 160 has an interface function to provide the encrypted data to the outside.

As just described, the output part 160 outputs the encrypted data generated by the encryption part 150.

The present embodiment makes deciphering difficult by dividing the plaintext data and changing the processing key to be used for the block cipher F for each unit of divisions (Le., unit of processing). As the block cipher F, an encryption algorithm that enables low latency processing can be applied. Therefore, in accordance with the present embodiment, high safety and the low latency processing can be both achieved.

It is preferable that an encryption algorithm having provable safety against differential cryptanalysis and linear cryptanalysis such as MISTY (registered trademark) or KASUMI is applied to the block cipher F. If the block cipher F includes the provable safety against the differential cryptanalysis and the linear cryptanalysis, it is possible to secure safety by setting as the unit of processing, the number of blocks same as the reciprocal of the average differential probability (or the average linear probability) of the block cipher F. For example, if the average differential probability of the block cipher F is 2⁻²⁴, 2²⁴ blocks should be the unit of processing. Note that the number of blocks less than the reciprocal of the average differential probability (or the average linear probability) of the block cipher F may be set as the unit of processing. Namely, the reciprocal of the average differential probability (or the average linear probability) of the block cipher F may be used as the upper limit. For example, if the average differential provability of the block cipher F is 2⁻²⁴, 2²³ blocks or fewer blocks may be the unit of processing.

As described above, it is preferable that the encryption algorithm having the provable safety against the differential cryptanalysis and the linear cryptanalysis is applied to the block cipher F. However, another encryption algorithm such as AES (Advanced Cryptographic Standard) can be also applied. In that case, the number of blocks for which certain safety can be expected should be set as the unit of processing. For example, blocks the number of which is a power of 2 (i.e., 2^{L/2}) whose exponent is half the number L of bits in one block (i.e., the block length) can be set as the unit of processing or the upper limit of the unit of processing. When the AES is used, the block length is 128 bits. Thus, 2⁶⁴ blocks or a fewer blocks should be the unit of processing.

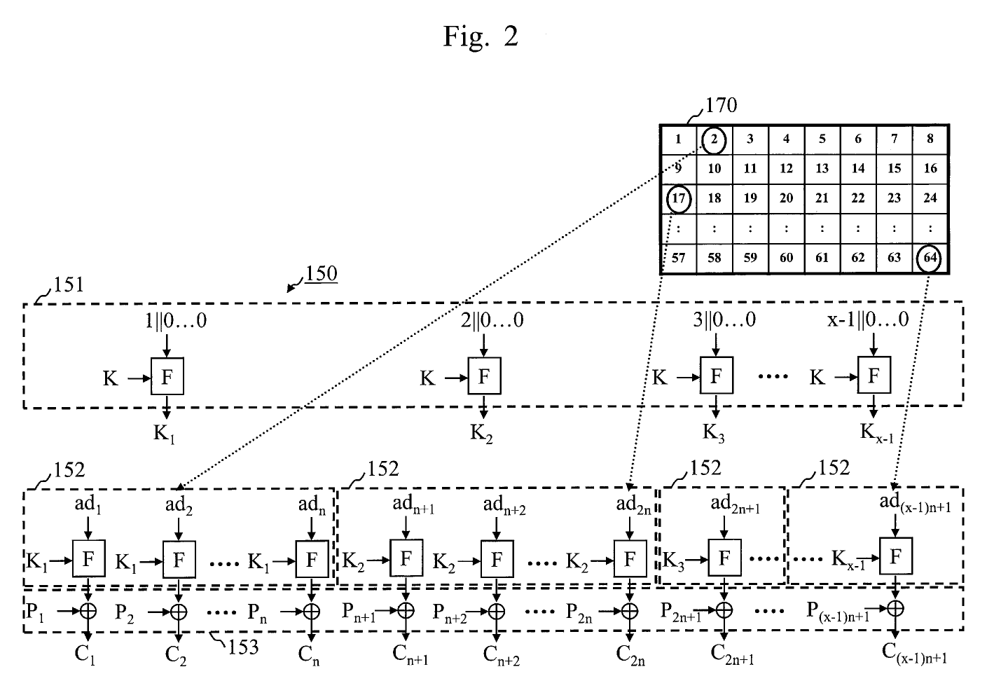

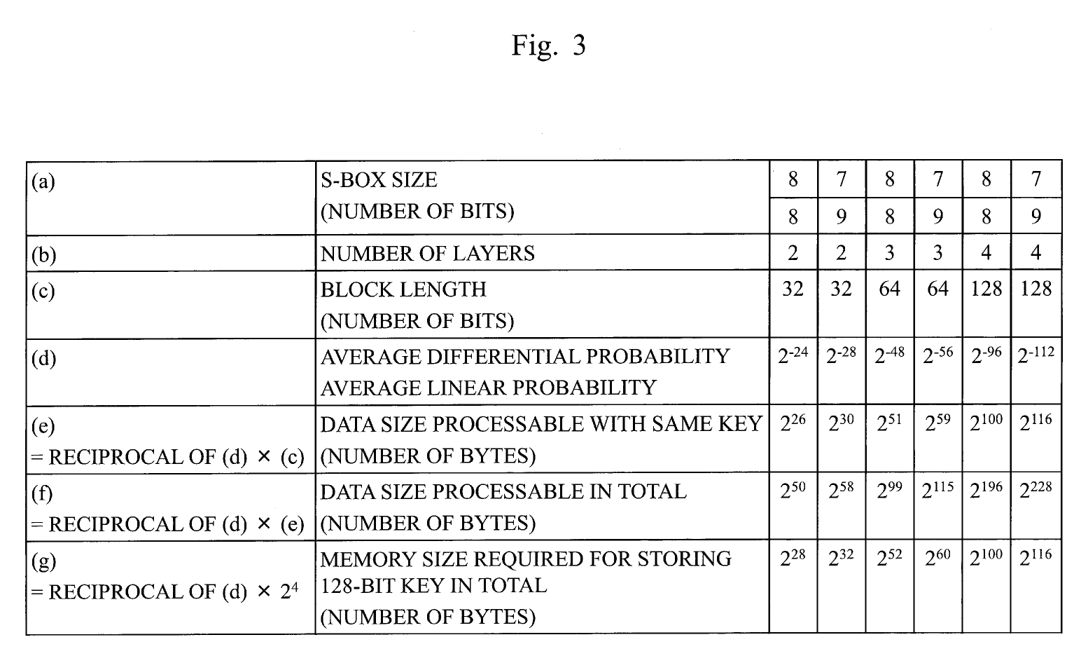

FIG. 2 is a block diagram illustrating a first configuration example of the encryption part 150. FIG. 3 is a table illustrating data sizes processable by the encryption apparatus 100.

The processing key generation part 151 is required to, in generating the processing keys from the common key, use an algorithm in which the original common key cannot be estimated from the processing keys. There are various alternatives for such an algorithm. For example, an encryption algorithm (i.e., the block cipher F) that is the same as the random data generation part 152 can be used.

Referring to the example of FIG. 2, the processing key generation part 151 uses a common key K as key data and imparts pieces of input data of 1, 2, . . . , and x−1, which are different from each other, to the block cipher F, thereby generating processing keys K₁, K₂, . . . , and Kₓ₋₁, which are different from each other. In this example, it is assumed that the encryption algorithm having the provable safety against the differential cryptanalysis and the linear cryptanalysis is applied to the block cipher F. The safety against the differential cryptanalysis and the linear cryptanalysis with respect to the processing keys can also be secured by using such an encryption algorithm for the generation of the processing keys.

As in the example of FIG. 3, the data size processable with one processing key varies with the configuration of the block cipher F. When the key length of the block cipher F is assumed to be 128 bits, in the example of FIG. 2, a configuration of the block cipher Fin which (c) the block length is 128 bits can be used. For example, if a configuration of the block cipher F in which (a) the S-box size is a combination of 8 bits and 8 bits, (b) the number of layers is 4,and (c) the block length is 128 bits is used, (d) the average differential probability and the average linear probability are each 2⁻⁹⁶. Thus, the unit of processing or the upper limit of the unit of processing is 2⁹⁶. Therefore, (e) the data size processable with the same processing key is 2¹⁰⁰ bytes (=2⁹⁶ ×128 bits). Since the processing keys are generated by means of the block cipher F, the number of the processing keys that can be generated from the same common key is also 2⁹⁶. Therefore, (f) the data size processable in total is 2¹⁹⁶ bytes (=2⁹⁶×2¹⁰⁰ bytes), and (g) the memory size required for storing the 128-bit processing keys is 2¹⁰⁰ bytes (=2⁹⁶×128 bits). Note that, in the example of FIG. 2, as the configuration of the block cipher F, another configuration also can be used. The key length of the block cipher F is not limited to 128 bits.

As just described, when the processing key generation part 151 generates the processing keys K₁, K₂, . . . , and Kₓ₋₁ by means of the block cipher F, it is possible to set the data size processable in total. When the size of the plaintext data input from the second input part 120 exceeds the data size processable in total, an additional common key K′ should be input from the first input part 110. By encrypting a portion of the plaintext data in excess over the data size processable in total, using the additional common key K′, the safety of that portion is also secured.

Referring to the example of FIG. 2, when the data size processable with one processing key is n blocks, the random data generation part 152 uses the processing key K₁ generated by the processing key generation part 151 as key data and imparts data addresses ad₁, ad₂, . . . , and adₙ to the block cipher F, thereby generating random data corresponding to the data addresses ad₁, ad₂, . . . , and adₙ. The random data generation part 152 uses the processing key K₂ generated by the processing key generation part 151 as key data and imparts data addresses adₙ₊₁, adₙ₊₂, . . . , and ad₂ₙ to the block cipher F, thereby generating random data corresponding to the data addresses adₙ₊₁, adₙ₊₂, . . . , and ad₂ₙ. The random data generation part 152 generates random data similarly with respect to the subsequent data addresses, using one processing key for each n blocks.

Referring to the example of FIG. 2, the encryption data processing part 153 computes an exclusive OR of each piece of the random data generated by the random data generation part 152 and the corresponding block of the plaintext data. The encryption data processing part 153 outputs the computation results C₁, C₂, . . . , and C₍ₓ₋₁₎ₙ₊₁ as the encrypted data.

When only data at one or some addresses is changed after data at all the addresses is encrypted, the random data generation part 152 identifies, from a memory map 170 of the encrypted data, the addresses where the data is changed. The encryption data processing part 153 should compute the exclusive OR of each piece of the random data and the corresponding block of the plaintext data (i.e., the changed data) with respect to only the addresses identified by the random data generation part 152. Therefore, it is possible to realize the low latency processing.

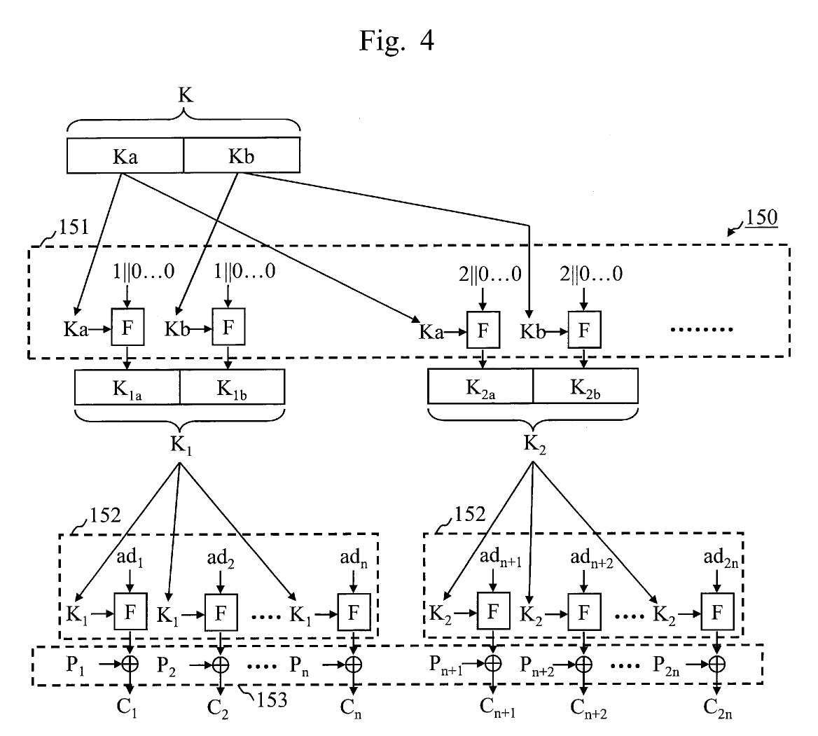

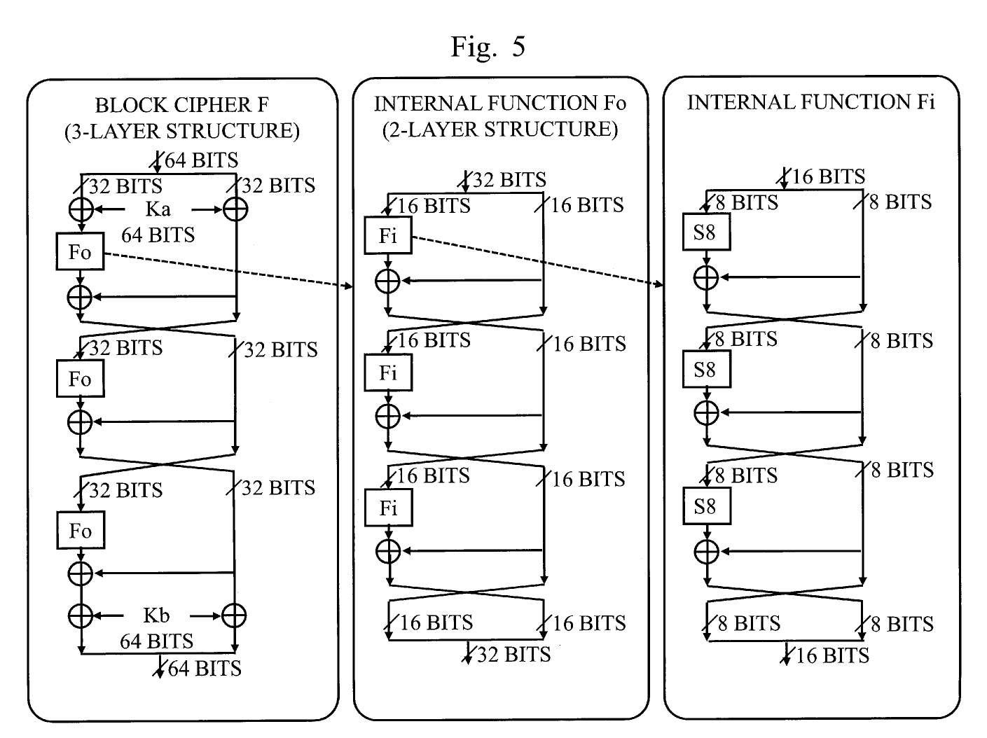

FIG. 4 is a block diagram illustrating a second configuration example of the encryption part 150. FIG. 5 is a diagram illustrating a configuration example of the block cipher F that can be used in the example of FIG. 4.

In the example of FIG. 2, a case in which the key length of the block cipher F and the block length are the same is assumed, but the key length of the block cipher F and the block length may be different with each other. For example, the key length may be twice the block length.

Referring to the example of FIG. 4, the processing key generation part 151 divides the common key K into partial keys Ka and Kb. The processing key generation part 151 uses each of the partial keys Ka and Kb as key data and imparts pieces of input data of 1, 2, . . . , and x−1, which are different from each other, to the block cipher F, thereby generating processing keys K₁, K₂, . . . , and Kₓ₋₁, which are different from each other. For example, the processing key generation part 151 uses each of the partial keys Ka, and Kb as the key data and inputs 1 to the block cipher F, thereby obtaining keys K₁ₐ and K_{1b}. Then, the processing key generation part 151 generates the processing key K₁ by concatenating the keys K₁ₐ and K_{1b}. In this example, it is also assumed that the encryption algorithm having the provable safety against the differential cryptanalysis and the linear cryptanalysis is applied to the block cipher F.

When the key length of the block cipher F is assumed to be 128 bits, in the example of FIG. 4, a configuration of the block cipher F in which the block length is 64 bits as in the example of FIG. 5 can be used. In the example of FIG. 5, 8-bit unit S-boxes are used. The average differential probability and the average linear probability of each S-box in itself are each 2⁻⁶. Since a configuration of each internal function Fi is a configuration having the provable safety against the differential cryptanalysis and the linear cryptanalysis, the average differential probability and the average linear probability of each internal function Fᵢ in itself are 2⁻¹². Similarly, since a configuration of each internal function Fo is a configuration having the provable safety against the differential cryptanalysis and the linear cryptanalysis, the average differential probability and the average linear probability of each internal function Fo in itself are each 2⁻²⁴. Since the configuration of the block cipher F is also a configuration having the provable safety against the differential cryptanalysis and the linear cryptanalysis, the average differential probability and the average linear probability of the entire block cipher F are each 2⁻⁴⁸. Referring to FIG. 3, in the example of FIG. 5, the configuration of the block cipher F in which (a) the S-box size is a combination of 8 bits and 8 bits, (b) the number of layers is 3, and (c) the block length is 64 bits is used, and (d) the average differential probability and the average linear probability are each 2⁻⁴⁸. Thus, the unit of processing or the upper limit of the unit of processing is 2⁴⁸. Therefore, (e) the data size processable with the same processing key is 2⁵¹ bytes (=2⁴⁸×64 bits). Since the processing keys are generated by means of the block cipher F, the number of the processing keys that can be generated from the same common key is also 2⁴⁸. Therefore, (f) the data size processable in total is 2⁹⁹ bytes (=2⁴⁸×2⁵¹ bytes), and (g) the memory size required for storing the 128-bit processing keys is 2⁵² bytes (=2⁴⁸×128 bits). Note that, in the example of FIG. 4, as the configuration of the block cipher F, a configuration that is different from the example of FIG. 5 also can be used. The key length of the block cipher F is not limited to 128 bits.

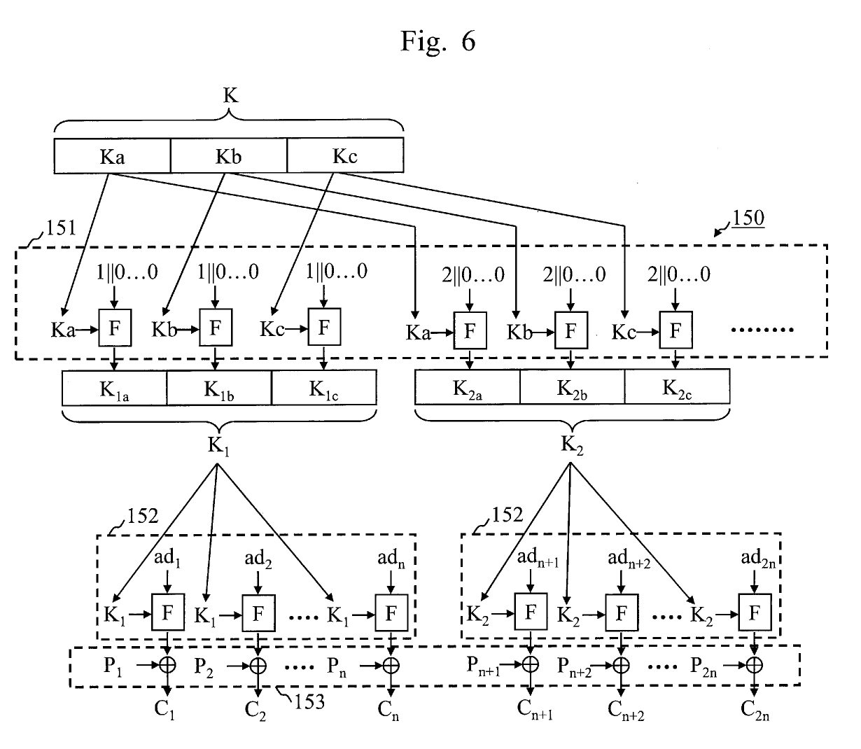

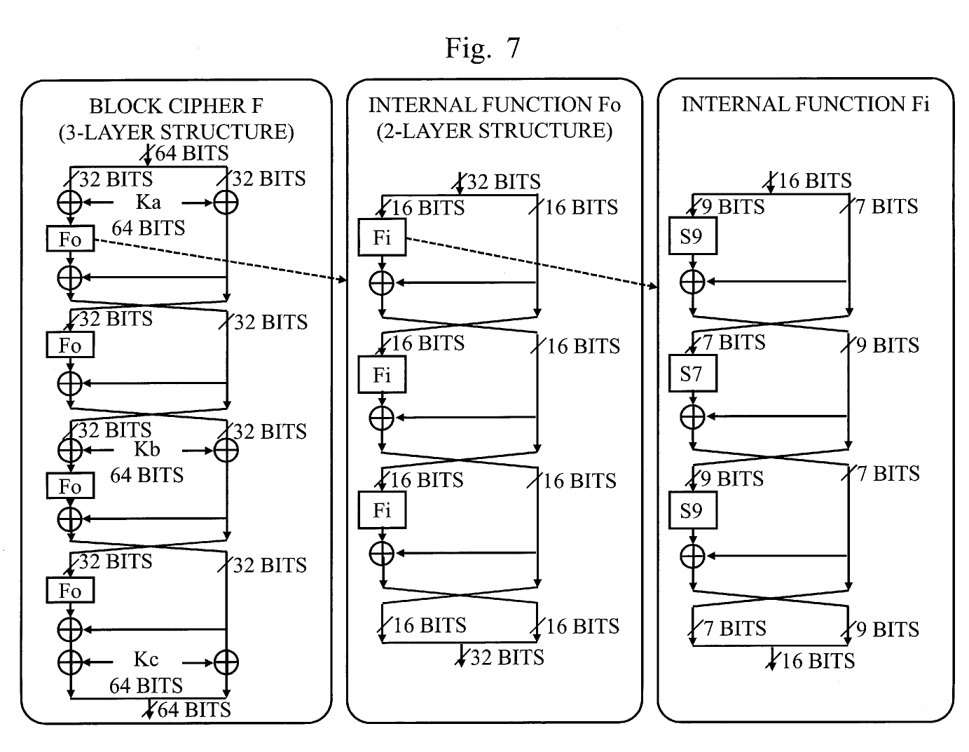

FIG. 6 is a block diagram illustrating a third configuration example of the encryption part 150. FIG. 7 is a diagram illustrating a configuration example of the block cipher F that can be used in the example of FIG. 6.

In the example of FIG. 4, the key length of the block cipher F is twice the block length. However, for example, the key length may be three times the block length.

Referring to the example of FIG. 6, the processing key generation part 151 divides the common key K into partial keys Ka, Kb, and Kc. The processing key generation part 151 uses each of the partial keys Ka, Kb, and Kc as key data and imparts pieces of input data of 1, 2, . . . , and x−1, which are different from each other, to the block cipher F, thereby generating the processing keys K₁, K₂, . . . , and Kₓ₋₁, which are different from each other. For example, the processing key generation part 151 uses each of the partial keys Ka, Kb, and Kc as the key data and inputs 1 to the block cipher F, thereby obtaining keys K₁ₐ, K_{1b}, and K_{1c}. Then, the processing key generation part 151 generates the processing key K₁ by concatenating the keys K₁ₐ, K_{1b}, and K_{1c}. In this example, it is also assumed that the encryption algorithm having the provable safety against the differential cryptanalysis and the linear cryptanalysis is applied to the block cipher F.

When the key length of the block cipher F is assumed to be 192 bits, in the example of FIG. 6, a configuration of the block cipher F in which the block length is 64 bits as in the example of FIG. 7 can be used. In the example of FIG. 7, 7-bit unit S-boxes and 9-bit unit S-boxes are used. The average differential probability and the average linear probability of each 7-bit unit S-box in itself are each 2⁻⁶. The average differential probability and the average linear probability of each 9-bit unit S-box in itself are each 2⁻⁸. Since a configuration of each internal function Fi is a configuration having the provable safety against the differential cryptanalysis and the linear cryptanalysis, the average differential probability and the average linear probability of each internal function Fᵢ in itself are each 2⁻¹⁴. Similarly, since a configuration of each internal function Fo is a configuration having the provable safety against the differential cryptanalysis and the linear cryptanalysis, the average differential probability and the average linear probability of each internal function Fo in itself are each 2⁻²⁸. Since the configuration of the block cipher F is also a configuration having the provable safety against the differential cryptanalysis and the linear cryptanalysis, the average differential probability and the average linear probability of the entire block cipher F are each 2⁻⁵⁶. Referring to FIG. 3, in the example of FIG. 7, the configuration of the block cipher F in which (a) the S-box size is a combination of 7 bits and 9 bits, (b) the number of layers is 3, and (c) the block length is 64 bits is used, and (d) the average differential probability and the average linear probability are each 2⁻⁵⁶. Thus, the unit of processing or the upper limit of the unit of processing is 2⁵⁶. Therefore, (e) the data size processable with the same processing key is 2⁵⁹ bytes (=2⁵⁶×64 bits). Since the processing keys are generated by means of the block cipher F, the number of the processing keys that can be generated from the same common key is also 2⁵⁶. Therefore, (f) the data size processable in total is 2¹¹⁵ bytes (=2⁵⁶×2⁵⁹ bytes). Although it is not indicated in FIG. 3, the memory size required for storing the 192-bit processing keys is about 2⁶¹ bytes (to be precise, 1.5×2⁶⁰ bytes≈2⁵⁶×192 bits). Note that, in the example of FIG. 6, as the configuration of the block cipher F, a configuration that is different from the example of FIG. 7 also can be used. The key length of the block cipher F is not limited to 192 bits.

If the internal configuration of the block cipher F to be used is changed, the safety of the block cipher F in itself is affected. However, the safety as the entire system can be secured by changing the processing key for each safe data size as in the examples of FIGS. 4 and 6.

In the example of FIG. 2, the encryption algorithm to be used by the random data generation part 152 is configured to secure the provable safety against the differential cryptanalysis and the linear cryptanalysis. It is possible to accommodate the algorithm that enables the low latency processing, by changing the configuration of the internal algorithm depending on required processing performance of the system, as in the examples of FIGS. 4 and 6, even with the same input/output interface. In the examples of FIGS. 4 and 6, the safety of the block cipher F against the differential cryptanalysis and the linear cryptanalysis is different. However, it is possible to secure the safety as the entire system by changing the data size processable with one processing key.

In the examples of FIGS. 4 and 6, the numbers of steps of the highest layer of the block cipher F are respectively 3 and 4 steps, which are different. Further, the S-boxes used in each internal function Fi are respectively one type of an 8-bit type and two types of 7-bit and 9-bit types, which are different. Because of these differences, lower latency processing is possible in the example of FIG. 4. Because of such differences in the configuration of the block cipher F, it is possible to realize a system where deterioration of the safety as a whole is prevented while realizing the system that enables the low latency processing, by trading off the processing performance required as the entire system and the memory size required for storing the processing keys.

As explained above, the encryption apparatus 100 according to the present embodiment determines the number of the divisions of the processing data that can secure safety with a single key from the numerically evaluated safety of the encryption algorithm in itself. The encryption apparatus 100 generates, from a secret key to be used in an encryption scheme that enables the low latency processing, processing keys the number of which is the same as the determined number of the divisions. The encryption apparatus 100 calculates the data addresses of the processing data. The encryption apparatus 100 generates, by using the encryption algorithm having the provable safety, the random data corresponding to the processing data by means of the corresponding processing keys. The encryption apparatus 100 generates the encrypted data from the processing data and the random data. Then, the encryption apparatus 100 outputs the encrypted data.

In accordance with the present embodiment, by simplifying the configuration of the encryption algorithm, it is possible to secure the safety of the encryption scheme as a whole while realizing the encryption scheme that enables the low latency processing. That is, the low latency processing and securing the safety can be realized at the same time.

### Second Embodiment

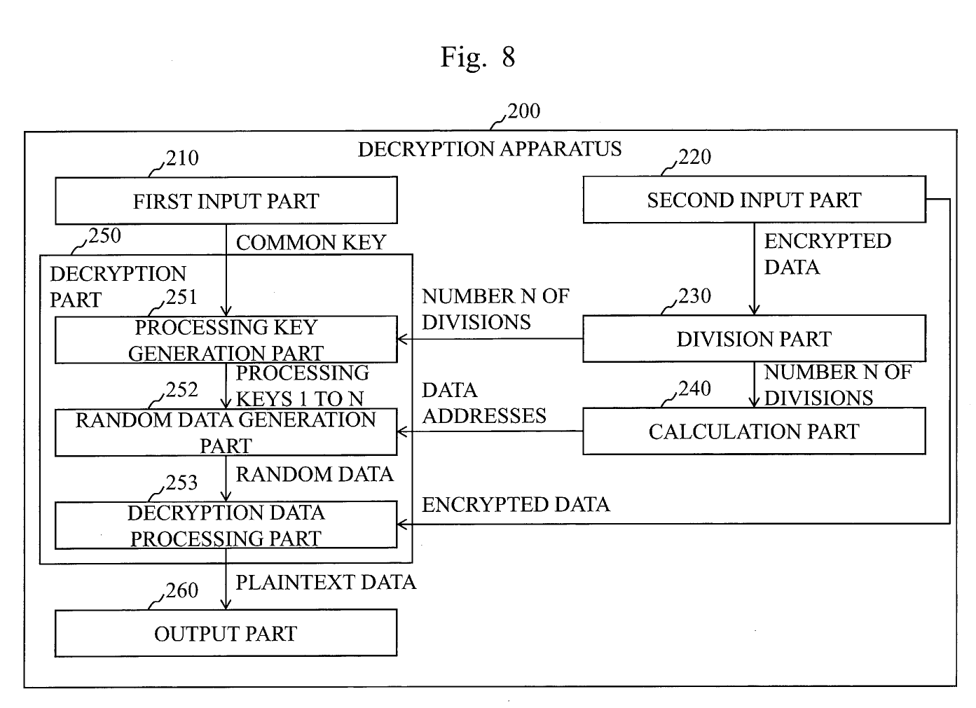

FIG. 8 is a block diagram illustrating a configuration of a decryption apparatus 200 according to the present embodiment.

The decryption apparatus 200 decrypts the encrypted data by means of a block cipher F. The block cipher F is the same as that of the first embodiment.

Referring to FIG. 8, the decryption apparatus 200 includes a first input part 210, a second input part 220, a division part 230, a calculation part 240, a decryption part 250, and an output part 260.

The first input part 210, the second input part 220, the division part 230, the calculation part 240, the decryption part 250, and the output part 260 respectively have functions corresponding to the first input part 110, the second input part 120, the division part 130, the calculation part 140, the encryption part 150, and the output part 160 of the encryption apparatus 100 according to the first embodiment.

The first input part 210 inputs a common key to the decryption part 250.

The second input part 220 inputs encrypted data to the division part 230 and the decryption part 250.

The division part 230 determines as a unit of processing, the number of blocks to be encrypted using the same key, and divides the encrypted data input from the second input part 220 by the unit of processing. The unit of processing is the same as that of the first embodiment.

The calculation part 240 calculates the data addresses of individual blocks of the encrypted data.

The decryption part 250 includes a processing key generation part 251, a random data generation part 252, and a decryption data processing part 253.

The processing key generation part 251, the random data generation part 252, and the decryption data processing part 253 respectively have functions corresponding to the processing key generation part 151, the random data generation part 152, and the encryption data processing part 153 of the encryption apparatus 100 according to the first embodiment.

The processing key generation part 251 generates from a common key input from the first input part 210, processing keys 1 to N which are different from each other and the number of which is the same as the number N of divisions of the encrypted data at the division part 230. For example, the processing key generation part 251 generates the processing keys 1 to N by encrypting pieces of data which are different from each other and the number of which is the same as the number N of the divisions of the encrypted data at the division part 230, by means of the block cipher F using the common key input from the first input part 210.

The random data generation part 252 and the decryption data processing part 253 generate plaintext data (i.e., decrypted data) by decrypting for each unit of processing determined by the division part 230, individual blocks of the encrypted data input from the second input part 220, by means of the block cipher F using the same processing key I (I=1, 2, . . . , and N) generated by the processing key generation part 251.

Specifically, the random data generation part 252 encrypts for each unit of processing determined by the division part 230, the data addresses of the individual blocks calculated by the calculation part 240, by means of the block cipher F using the same processing key I generated by the processing key generation part 251. The decryption data processing part 253 generates the decrypted data from the data addresses of the individual blocks encrypted by the random data generation part 252 and the individual blocks of the encrypted data input from the second input part 220. For example, the decryption data processing part 253 calculates an exclusive OR of each of the data addresses of the individual blocks encrypted by the random data generation part 252 and a corresponding one of the individual blocks of the encrypted data input from the second input part 220, and outputs the calculation result as the decrypted data.

The output part 260 outputs the decrypted data generated by the decryption part 250.

In the present embodiment, decryption processing corresponding to the encryption processing in the first embodiment is performed. Therefore, in accordance with the present embodiment, high safety and the low latency processing can be both realized in the same manner as the first embodiment.

### Third Embodiment

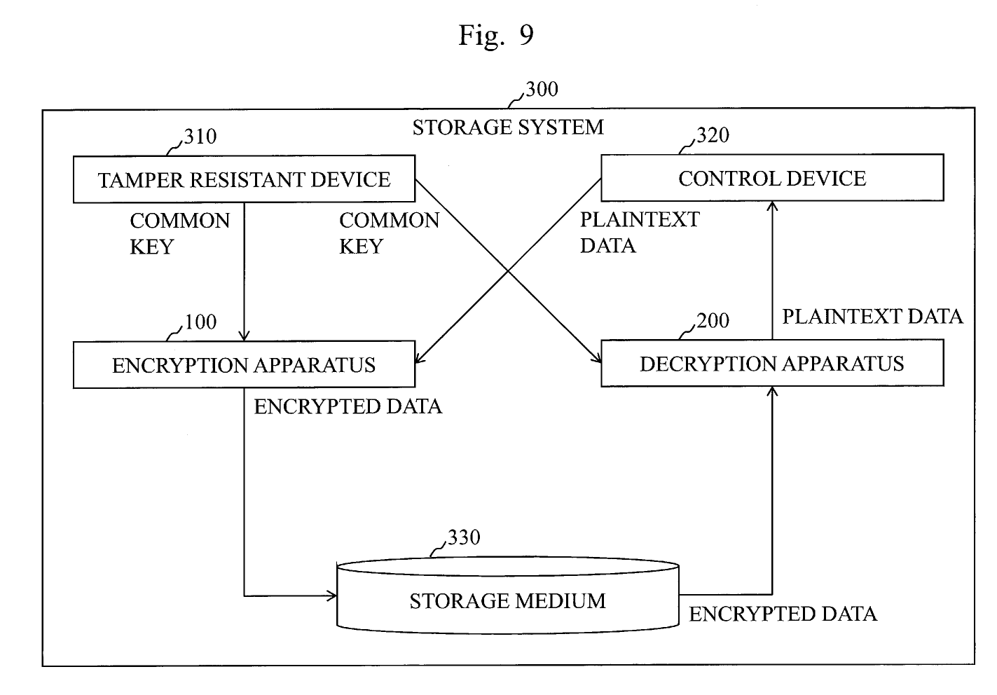

FIG. 9 is a block diagram illustrating a configuration of a storage system 300 according to the present embodiment.

Referring to FIG. 9, the storage system 300 includes the same encryption apparatus 100 as the first embodiment and the same decryption apparatus 200 as the second embodiment. Further, the storage system 300 includes a tamper resistant device 310, a control device 320, and a storage medium 330.

The tamper resistant device 310 stores a common key. The common key is the same as those in the first and second embodiments.

When receiving from the outside a request to write data to the storage medium 330, the control device 320 transmits to the encryption apparatus 100 an instruction to write the data to the storage medium 330, and also transmits the common key from the tamper resistant device 310 to the encryption apparatus 100. Further, when receiving from the outside a request to read data from a specific address of the storage medium 330, the control device 320 transmits to the decryption apparatus 200 an instruction to read the data from the address, and also transmits the common key from the tamper resistant device 310 to the decryption apparatus 200. When receiving data from the decryption apparatus 200, the control device 320 provides the received data to the outside.

The storage medium 330 (e.g., a hard disk) stores encrypted data.

It is preferable that the encryption apparatus 100 and the decryption apparatus 200 are implemented integrally (e.g., in a single integrated circuit chip).

When receiving the common key and the instruction to write the data (i.e., the plaintext data) to the storage medium 330, the encryption apparatus 100 generates the encrypted data by the encryption part 150, and writes the encrypted data to the storage medium 330.

When receiving the common key and the instruction to read the data from the specific address of the storage medium 330, the decryption apparatus 200 reads the encrypted data from the address, generates the plaintext data by the decryption part 250, and outputs the data to the control device 320.

In the storage medium 330, data at all addresses is encrypted. However, the random data generation part 252 of the decryption part 250 can generate random data from the address specified in the instruction from the control device 320. Hence, the decryption data processing part 253 of the decryption part 250 can restore the plaintext data by computing, only with respect to the address specified in the instruction from the control device 320, an exclusive OR of each piece of the random data generated by the random data generation part 252 and a corresponding one of blocks of the encrypted data stored in the storage medium 330. Therefore, in the present embodiment, it is possible to hold the data safely in the storage medium 330, and it is also possible to read the required data from the storage medium 330 at high speed.

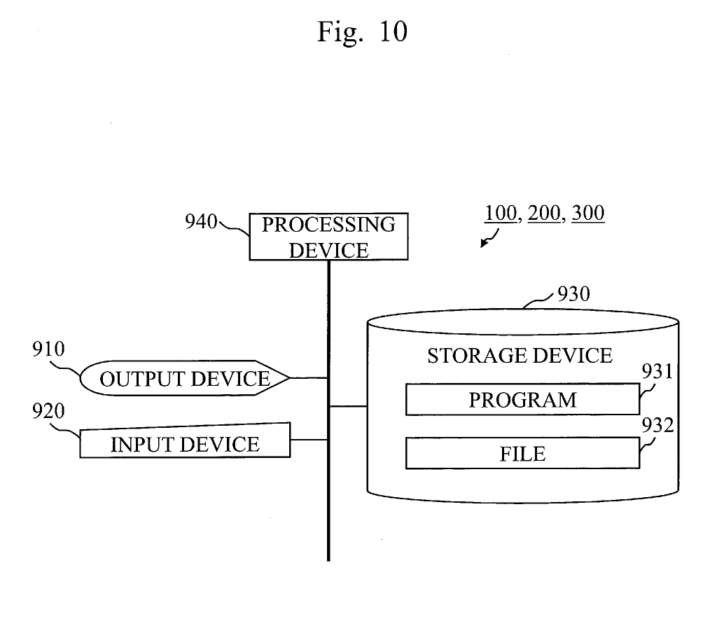

FIG. 10 is a diagram illustrating one example of a hardware configuration of each of the encryption apparatus 100, the decryption apparatus 200, and the storage system 300 according to the embodiments of the present invention.

Referring to FIG. 10, the encryption apparatus 100, the decryption apparatus 200, and the storage system 300 are computers individually and each include hardware such as an output device 910, an input device 920, a storage device 930, and a processing device 940. The hardware is used by each part (each one described as a “part” in the description of the embodiments of the present invention) of the encryption apparatus 100, the decryption apparatus 200, and the storage system 300.

The output device 910 is, for example, a display device such as an LCD (Liquid Crystal Display), a printer, or a communication module (a communication circuit or the like). The output device 910 is used to output (transmit) data, information, and a signal by each one described as a “part” in the description of the embodiments of the present invention.

The input device 920 is, for example, a keyboard, a mouse, a touch panel, or a communication module (communication circuit or the like). The input device 920 is used to input (receive) the data, the information, and the signal by each one described as a “part” in the description of the embodiments of the present invention.

The storage device 930 is, for example, a ROM (Read Only Memory), a RAM (Random Access Memory), an HDD (Hard Disk Drive), or an SSD (Solid State Drive). The storage device 930 stores a program 931 and a file 932. The program 931 includes a program for executing the process (function) of the each described as a “part” in the description of the embodiments of the present invention. The file 932 includes the data, the information, the signal (value), and the like for which calculation, processing, reading, writing, use, input, output, and the like are performed by each one described as a “part” in the description of the embodiments of the present invention.

The processing device 940 is, for example, a CPU (Central Processing Unit). The processing device 940 is connected to other hardware devices via a bus or the like and controls the hardware devices. The processing device 940 reads the program 931 from the storage device 930 and executes the program 931. The processing device 940 is used for the calculation, processing, reading, writing, use, input, output, and the like by each one described as a “part” in the description of the embodiments of the present invention.

Each one described as a “part” in the description of the embodiments of the present invention may be the one for which the “part” is replaced by a “circuit”, a “device”, or an “appliance”. Further, each one described as a “part” in the description of the embodiments of the present invention may be the one for which the “part” is replaced by a “step”, a “procedure”, or a “process”. That is, each one described as a “part” in the description of the embodiments of the present invention is realized solely by software, solely by hardware, or by a combination of the software and the hardware. The software is stored in the storage device 930 as the program 931. The program 931 causes the computer to function as each one described as a “part” in the description of the embodiments of the present invention. Alternatively, the program 931 causes the computer to execute the process of each one described as a “part” in the description of the embodiments of the present invention. Alternatively, the program 931 causes the computer to execute the process of each one described as a “part” in the description of the embodiments of the present invention.

The embodiments of the present invention has been described above. From among the embodiments, some may be combined and implemented. Alternatively, from among the embodiments, any one or some may be implemented partially. For example, only one of the ones each described as a “part” in the description of the embodiments may be employed, or any arbitrary combination of some of the ones may be employed. Note that, the present invention is not limited to the embodiments, and various modifications can be made as necessary.

### REFERENCE SIGNS LIST

100: encryption apparatus, 110: first input part, 120: second input part, 130: division part, 140: calculation part, 150: encryption part, 151: processing key generation part, 152: random data generation part, 153: encryption data processing part, 160: output part, 170: memory map, 200: decryption apparatus, 210: first input part, 220: second input part, 230: division part, 240: calculation part, 250: decryption part, 251: processing key generation part, 252: random data generation part, 253: decryption data processing part, 260: output part, 300: storage system, 310: tamper resistant device, 320: control device, 330: storage medium, 910: output device, 920: input device, 930: storage device, 931: program, 932: file, and 940: processing device

1-20. (canceled)

21. An encryption apparatus to encrypt plaintext data by means of a block cipher, the encryption apparatus comprising:
a division part to determine as a unit of processing, a number of blocks to be encrypted using a same key, and divide the plaintext data by the unit of processing;
an encryption part to generate from a common key, processing keys which are different from each other and a number of which is same as a number of divisions of the plaintext data at the division part, and generate encrypted data by encrypting for each unit of processing determined by the division part, individual blocks of the plaintext data by means of the block cipher using same one of the generated processing keys; and
a calculation part to calculate data addresses of the individual blocks of the plaintext data,
wherein the encryption part encrypts for each unit of processing determined by the division part, the data addresses of the individual blocks calculated by the calculation part, by means of the block cipher using the same one of the generated processing keys, and generates the encrypted data from the encrypted data addresses of the individual blocks and the individual blocks of the plaintext data.

22. The encryption apparatus according to claim 21,
wherein the encryption part calculates an exclusive OR of each of the encrypted data addresses of the individual blocks and a corresponding one of the individual blocks of the plain text data, and outputs a calculation result as the encrypted data.

23. The encryption apparatus according to claim 21,
wherein the encryption part generates the processing keys by encrypting pieces of data which are different from each other and a number of which is same as the number of the divisions of the plaintext data at the division part, by means of the block cipher using the common key.

24. An encryption apparatus to encrypt plaintext data by means of a block cipher, the encryption apparatus comprising:
a division part to determine as a unit of processing, a number of blocks to be encrypted using a same key, and divide the plaintext data by the unit of processing; and
an encryption part to generate from a common key, processing keys which are different from each other and a number of which is same as a number of divisions of the plaintext data at the division part, and generate encrypted data by encrypting for each unit of processing determined by the division part, individual blocks of the plaintext data by means of the block cipher using same one of the generated processing keys,
wherein the encryption part generates the processing keys by encrypting pieces of data which are different from each other and a number of which is same as the number of the divisions of the plaintext data at the division part, by means of the block cipher using the common key.

25. The encryption apparatus according to claim 21,
wherein the division part determines the unit of processing depending on a configuration of the block cipher.

26. The encryption apparatus according to claim 21,
wherein the division part determines the unit of processing depending on an average differential probability or an average linear probability of the block cipher.

27. The encryption apparatus according to claim 21,
wherein the division part determines a reciprocal of the average differential probability or the average linear probability of the block cipher as the unit of processing.

28. A storage system comprising:
the encryption apparatus according to claim 21; and
a storage medium to store data,
wherein when receiving the common key and an instruction to write the plaintext data to the storage medium, the encryption apparatus generates the encrypted data by the encryption part, and writes the encrypted data to the storage medium.

29. A decryption apparatus to decrypt encrypted data by means of a block cipher, the decryption apparatus comprising:
a division part to determine as a unit of processing, a number of blocks to be decrypted using a same key, and divide the encrypted data by the unit of processing;
a decryption part to generate from a common key, processing keys which are different from each other and a number of which is same as a number of divisions of the encrypted data at the division part, and generate plaintext data by decrypting for each unit of processing determined by the division part, individual blocks of the encrypted data by means of the block cipher using same one of the generated processing keys; and
a calculation part to calculate data addresses of the individual blocks of the encrypted data,
wherein the decryption part encrypts for each unit of processing determined by the division part, the data addresses of the individual blocks calculated by the calculation part, by means of the block cipher using the same one of the generated processing keys, and generates the plaintext data from the encrypted data addresses of the individual blocks and the individual blocks of the encrypted data.

30. The decryption apparatus according to claim 29,
wherein the decryption part calculates an exclusive OR of each of the encrypted data addresses of the individual blocks and a corresponding one of the individual blocks of the encrypted data, and outputs a calculation result as the plaintext data.

31. The decryption apparatus according to claim 29,
wherein the decryption part generates the processing keys by encrypting pieces of data which are different from each other and a number of which is same as the number of the divisions of the encrypted data at the division part, by means of the block cipher using the common key.

32. A decryption apparatus to decrypt encrypted data by means of a block cipher, the decryption apparatus comprising:
a division part to determine as a unit of processing, a number of blocks to be decrypted using a same key, and divide the encrypted data by the unit of processing; and
a decryption part to generate from a common key, processing keys which are different from each other and a number of which is same as a number of divisions of the encrypted data at the division part, and generate plaintext data by decrypting for each unit of processing determined by the division part, individual blocks of the encrypted data by means of the block cipher using same one of the generated processing keys,
wherein the decryption part generates the processing keys by encrypting pieces of data which are different from each other and a number of which is same as the number of the divisions of the encrypted data at the division part, by means of the block cipher using the common key.

33. The decryption apparatus according to claim 29,
wherein the division part determines the unit of processing depending on a configuration of the block cipher.

34. The decryption apparatus according to claim 29,
wherein the division part determines the unit of processing depending on an average differential probability or an average linear probability of the block cipher.

35. The decryption apparatus according to claim 29,
wherein the division part determines a reciprocal of the average differential probability or the average linear probability of the block cipher as the unit of processing.

36. A storage system comprising:
the decryption apparatus according to claim 29; and
a storage medium to store the encrypted data,
wherein when receiving the common key and an instruction to read data from the storage medium, the decryption apparatus reads the encrypted data from the storage medium, generates the plaintext data by the decryption part, and outputs the plaintext data.

37. An encryption method to encrypt plaintext data by means of a block cipher, the encryption method comprising:
determining as a unit of processing, by a computer, a number of blocks to be encrypted using a same key, and dividing the plaintext data by the unit of processing;
generating by the computer, from a common key, processing keys which are different from each other and a number of which is same as a number of divisions of the plaintext data, and generating by the computer, encrypted data by encrypting for each unit of processing, individual blocks of the plaintext data by means of the block cipher using same one of the generated processing keys; and
calculating by the computer, data addresses of the individual blocks of the plaintext data,
wherein the computer encrypts for each determined unit of processing, the calculated data addresses of the individual blocks, by means of the block cipher using the same one of the generated processing keys, and generates the encrypted data from the encrypted data addresses of the individual blocks and the individual blocks of the plaintext data.

38. An encryption method to encrypt plaintext data by means of a block cipher, the encryption method comprising:
determining as a unit of processing, by a computer, a number of blocks to be encrypted using a same key, and dividing the plaintext data by the unit of processing; and
generating by the computer, from a common key, processing keys which are different from each other and a number of which is same as a number of divisions of the plaintext data, and generating by the computer, encrypted data by encrypting for each unit of processing, individual blocks of the plaintext data by means of the block cipher using same one of the generated processing keys,
wherein the computer generates the processing keys by encrypting pieces of data which are different from each other and a number of which is same as the number of the divisions of the plaintext data, by means of the block cipher using the common key.

39. A decryption method to decrypt encrypted data by means of a block cipher, the decryption method comprising:
determining as a unit of processing, by a computer, a number of blocks to be decrypted using a same key, and dividing the encrypted data by the unit of processing;
generating by the computer, from a common key, processing keys which are different from each other and a number of which is same as a number of divisions of the encrypted data, and generating by the computer, plaintext data by decrypting for each unit of processing, individual blocks of the encrypted data by means of the block cipher using same one of the generated processing keys; and
calculating by the computer, data addresses of the individual blocks of the encrypted data,
wherein the computer encrypts for each determined unit of processing, the calculated data addresses of the individual blocks, by means of the block cipher using the same one of the generated processing keys, and generates the plaintext data from the encrypted data addresses of the individual blocks and the individual blocks of the encrypted data.

40. A decryption method to decrypt encrypted data by means of a block cipher, the decryption method comprising:
determining as a unit of processing, by a computer, a number of blocks to be decrypted using a same key, and dividing the encrypted data by the unit of processing; and
generating by the computer, from a common key, processing keys which are different from each other and a number of which is same as a number of divisions of the encrypted data, and generating by the computer, plaintext data by decrypting for each unit of processing, individual blocks of the encrypted data by means of the block cipher using same one of the generated processing keys,
wherein the computer generates the processing keys by encrypting pieces of data which are different from each other and a number of which is same as the number of the divisions of the encrypted data, by means of the block cipher using the common key.

41. A non-transitory computer readable medium storing an encryption program to encrypt plaintext data by means of a block cipher, the encryption program to cause a computer to execute:
division processing to determine as a unit of processing, a number of blocks to be encrypted using a same key, and divide the plaintext data by the unit of processing;
encryption processing to generate from a common key, processing keys which are different from each other and a number of which is same as a number of divisions of the plaintext data at the division processing, and generate encrypted data by encrypting for each unit of processing determined by the division processing, individual blocks of the plaintext data by means of the block cipher using same one of the generated processing keys; and
calculation processing to calculate data addresses of the individual blocks of the plaintext data,
wherein the encryption processing encrypts for each unit of processing determined by the division processing, the data addresses of the individual blocks calculated by the calculation processing, by means of the block cipher using the same one of the generated processing keys, and generates the encrypted data from the encrypted data addresses of the individual blocks and the individual blocks of the plaintext data.

42. A non-transitory computer readable medium storing an encryption program to encrypt plaintext data by means of a block cipher, the encryption program to cause a computer to execute:
division processing to determine as a unit of processing, a number of blocks to be encrypted using a same key, and divide the plaintext data by the unit of processing; and
encryption processing to generate from a common key, processing keys which are different from each other and a number of which is same as a number of divisions of the plaintext data at the division processing, and generate encrypted data by encrypting for each unit of processing determined by the division processing, individual blocks of the plaintext data by means of the block cipher using same one of the generated processing keys,
wherein the encryption processing generates the processing keys by encrypting pieces of data which are different from each other and a number of which is same as the number of the divisions of the plaintext data at the division processing, by means of the block cipher using the common key.

43. A non-transitory computer readable medium storing a decryption program to decrypt encrypted data by means of a block cipher, the decryption program to cause a computer to execute:
division processing to determine as a unit of processing, a number of blocks to be decrypted using a same key, and divide the encrypted data by the unit of processing;
decryption processing to generate from a common key, processing keys which are different from each other and a number of which is same as a number of divisions of the encrypted data at the division processing, and generate plaintext data by decrypting for each unit of processing determined by the division processing, individual blocks of the encrypted data by means of the block cipher using same one of the generated processing keys; and
calculation processing to calculate data addresses of the individual blocks of the encrypted data,
wherein the decryption processing encrypts for each unit of processing determined by the division processing, the data addresses of the individual blocks calculated by the calculation processing, by means of the block cipher using the same one of the generated processing keys, and generates the plaintext data from the encrypted data addresses of the individual blocks and the individual blocks of the encrypted data.

44. A non-transitory computer readable medium storing a decryption program to decrypt encrypted data by means of a block cipher, the decryption program to cause a computer to execute:
division processing to determine as a unit of processing, a number of blocks to be decrypted using a same key, and divide the encrypted data by the unit of processing; and
decryption processing to generate from a common key, processing keys which are different from each other and a number of which is same as a number of divisions of the encrypted data at the division processing, and generate plaintext data by decrypting for each unit of processing determined by the division processing, individual blocks of the encrypted data by means of the block cipher using same one of the generated processing keys,
wherein the decryption processing generates the processing keys by encrypting pieces of data which are different from each other and a number of which is same as the number of the divisions of the encrypted data at the division processing, by means of the block cipher using the common key.
